(19) United States
(12) Patent Application Publication
(10) Pub. No.: US 2016/0281798 A1
(43) Pub. Date: Sep. 29, 2016

(54) CLUTCH SYNCHRONIZER RINGS HAVING ENHANCED LUBRICATION

(71) Applicant: GM Global Technology Operations LLC, Detroit, MI (US)

(72) Inventors: SHACHINDRA DONGAONKAR, Bangalore (IN); DEEPAK KUMAR SAHU, Bangalore (IN)

(21) Appl. No.: 15/000,753

(22) Filed: Jan. 19, 2016

Related U.S. Application Data
(60) Provisional application No. 62/136,909, filed on Mar. 23, 2015.

(51) Int. Cl. F16D 23/02

(52) U.S. Cl. CPC F16D 23/025; F16D 2300/06

(57) ABSTRACT

A synchronizer assembly for use in manual transmissions has enhanced lubrication and improved service life. The synchronizer assembly includes an outer, blocker ring, an intermediate ring and an inner ring. A plurality of circumferentially spaced apart radial holes in the intermediate and inner rings directs lubrication oil to the inner surfaces of both the intermediate ring and the blocker ring to reduce friction and enhance heat dissipation into the lubricating oil and away from the synchronizer.

### CROSS REFERENCE TO RELATED APPLICATION

This application claims the benefit of U.S. Provisional Patent Application Ser. No. 62/136,909, filed Mar. 23, 2015, which is hereby incorporated in its entirety herein by reference.

### FIELD

The present disclosure relates to synchronizers for use in manual motor vehicle transmissions and more particularly to synchronizers for use in manual motor vehicle transmissions having enhanced lubrication and thus extended service life.

### BACKGROUND

The statements in this section merely provide background information related to the present disclosure and may or may not constitute prior art.

Synchronizers are a necessary component of modern manual transmissions which were once referred to as synchromesh transmissions. Synchronizers are essentially clutches in themselves that reside between a shift collar and each gear on a shaft or countershaft which synchronize the about to be engaged gear with the shift collar so that the shift collar and gear can be easily, quickly and quietly coupled to transmit torque from, for example, the shaft, through the shift collar, through the gear and to another gear.

Depending upon the speed differential between the shift collar and the selected gear, significant heat can be generated as the synchronizer slows the faster moving component or speeds the slower moving component. Additionally, if a particular shift is repeated within a short period of time, heat from one synchronization may not be dissipated before more heat is generated in the synchronizer by a second or third synchronization. This may readily occur with upshift and downshifts involving the same gear.

It is apparent, therefore, that heat generation in manual transmission synchronizers can be significant and can lead to reduced service life of such components. The present invention is directed to enhancing lubrication of such synchronizers and improving their service life.

### SUMMARY

The present invention provides a synchronizer assembly for use in manual transmissions having enhanced lubrication and improved service life. The synchronizer assembly includes an outer, blocker ring, an intermediate ring and an inner ring. A plurality of circumferentially spaced apart radial holes in the intermediate and inner rings directs lubrication oil to the inner surfaces of both the intermediate ring and the blocker ring to reduce friction and enhance heat dissipation into the lubricating oil and away from the synchronizer.

Thus it is an aspect of the present invention to provide a manual transmission synchronizer having enhanced lubrication and improved service life.

It is a further aspect of the present invention to provide a manual transmission synchronizer having a plurality of radial lubrication holes in an inner ring.

It is a still further aspect of the present invention to provide a manual transmission synchronizer having a plurality of radial lubrication holes in an intermediate ring.

It is a still further aspect of the present invention to provide a manual transmission synchronizer having a plurality of radial lubrication holes in both an inner ring and an intermediate ring.

It is a still further aspect of the present invention to provide a manual transmission synchronizer having a plurality of circumferentially spaced apart radial lubrication holes in both an inner ring and an intermediate ring.

It is a still further aspect of the present invention to provide a manual transmission clutch having a synchronizer including a plurality of radial lubrication holes in both an inner ring and an intermediate ring.

It is a still further aspect of the present invention to provide a manual transmission clutch having a synchronizer including a plurality of circumferentially spaced apart radial lubrication holes in both an inner ring and an intermediate ring.

Further advantages, aspects and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a manual transmission synchronizer assembly, associated gears and shaft incorporating the present invention;

FIG. 2 is a full sectional view of a manual transmission synchronizer assembly, associated gears and shaft incorporating the present invention; and

FIG. 3 is a perspective view of a complete synchronizer assembly according to the present invention;

FIG. 4 is a perspective view of the intermediate and inner rings of a synchronizer assembly according to the present invention,

FIG. 5 is a perspective view of the intermediate ring of a synchronizer assembly according to the present invention; and

FIG. 6 is a perspective view of the inner ring of a synchronizer assembly according to the present invention.

### DETAILED DESCRIPTION

The following description is merely exemplary in nature and is not intended to limit the present disclosure, application, or uses.

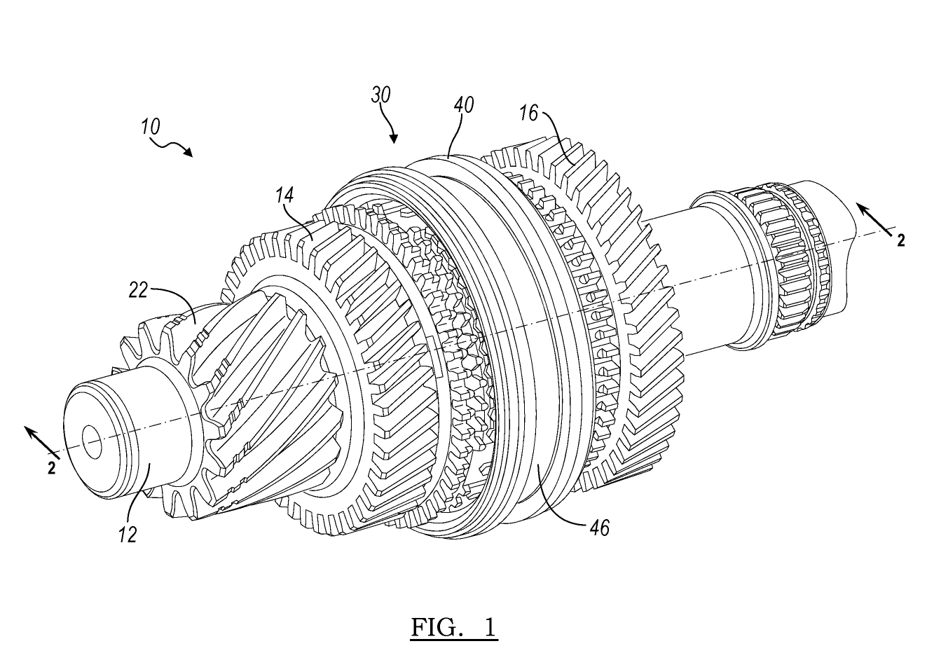

With reference now to FIG. 1, a portion of a manual transmission, namely a shaft, a pair of gears disposed on the shaft and a synchronizer assembly disposed on the shaft between the pair of gears, is illustrated and generally designated by the reference numeral 10. The portion 10 of the manual transmission 10, the shaft 12, a first gear 14, a second gear 16 and the synchronizer assembly 30 are typically one of several such assemblies disposed in parallel within the transmission (not illustrated) which provide, for example, first and second forward gears, third and fourth forward gears and higher forward gears and reverse depending upon the configuration of the transmission.

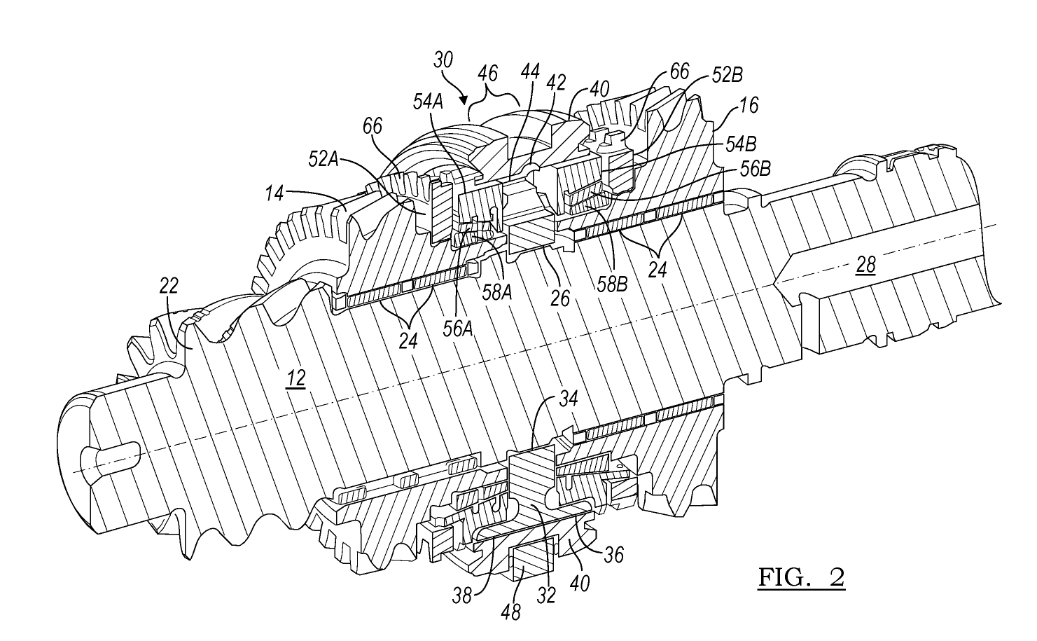

With reference now to FIG. 2, the shaft 12 which may be an input shaft, a lay shaft or a countershaft includes an integrally formed gear 22 which is either driven by or drives other gears in the transmission, two pairs of roller bearing assemblies 24 that freely rotationally support the first and second gears 14 and 16, respectively, a set of male or external splines 26 formed in the shaft 12 between the roller bearing assemblies 24 and a lubrication passageway 28 which provides transmission oil to various components of the transmission.

The synchronizer assembly 30 includes a center hub 32 having internal or female splines 34 which are complementary to and engage the male splines 26 on the shaft 12. The center hub 32, in turn, includes male or external splines 36 which are complementary to and engage female or internal splines 38 on a shift sleeve or collar 40. The shift sleeve or collar 40 includes an inner groove 42 into which one or preferably a plurality of detenting springs 44 reside. The detenting springs 44, in accordance with conventional practice, provide resistance to moving the shift sleeve or collar 40 axially out of the position illustrated in FIG. 2 and urge the sleeve or collar 40 into such position as it is approached from the left or right. The shift sleeve or collar 40 includes an outer peripheral channel or groove 46 which receives a shift fork 48 which translates the shift sleeve or collar 40 axially to the left or right. The shift fork 48 is coupled through a linkage to a shift knob or lever which is under the control of the vehicle operator (all not illustrated).

The synchronizer assembly 30 is essentially symmetrical and includes left and right engagement rings 52A and 52B which are coupled to the respective, adjacent gears 14 and 16 by interengaging splines (not illustrated). The synchronizer assembly 30 also includes left and right blocker rings 54A and 54B, left and right intermediate rings 56A and 56B and left and right inner rings 58A and 58B. Accordingly, only one of the sides, the right side, including the right engagement ring 52B, the right blocker ring 54B, the right intermediate ring 56B and the right inner ring 58B will be described in further detail, it being understood that this explanation applies fully to the components of the left side of the synchronizer assembly 30 designated by the suffix letter A.

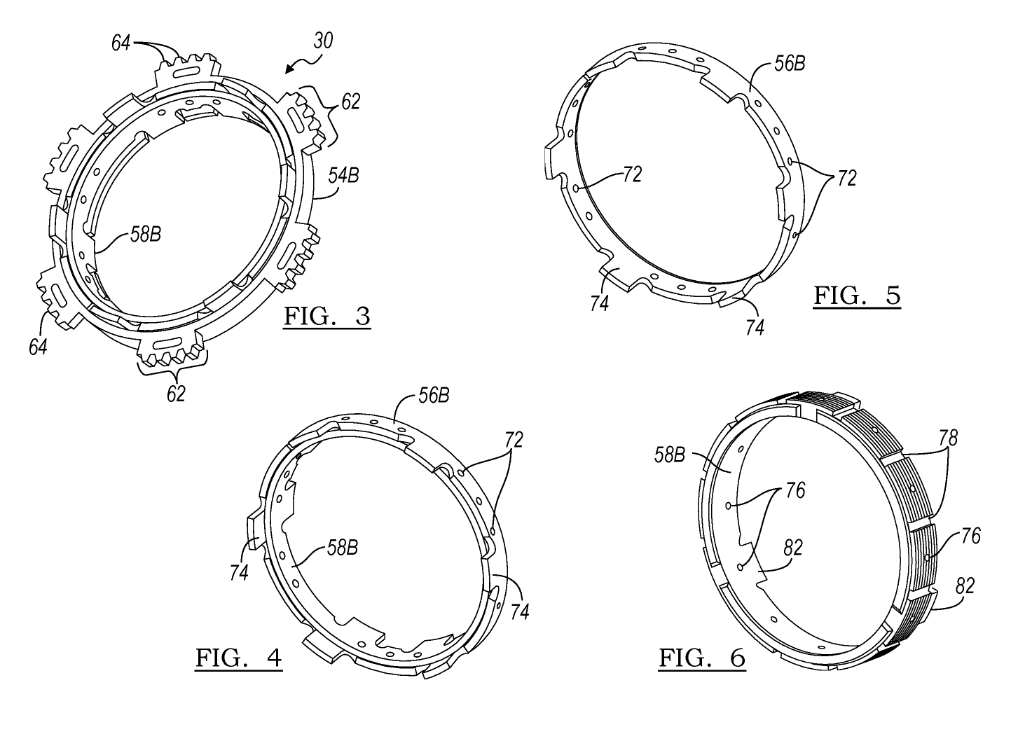

Referring now to FIGS. 2 and 3, a complete right synchronizer assembly 30 is illustrated which includes the blocker ring 54B which receives the intermediate ring 56B which, in turn, receives the inner ring 58B. The blocker ring 54B includes peripheral discontinuous, i.e., circumferentially spaced apart, segments 62 of teeth 64 which have the same diameter and pitch as teeth 66 on the engagement ring 52B.

Referring now to FIGS. 4 and 5, the intermediate ring 56B, which, as illustrated in FIG. 3, is seated within the blocker ring 54B, includes a plurality of radially oriented, circumferentially spaced apart through lubrication apertures, holes or openings 72. The lubrication openings 72 allow and encourage lubricating oil to flow into the interface between the outer surface of the intermediate ring 56B and the inner surface of the blocking ring 54B. While the number of openings 72 and their diameter may vary, for example, according to the diameter and width of the intermediate ring 56B, a range of from eight to sixteen openings 72 has been found functional and between ten and fourteen is preferred. In a typical intermediate ring 56B having a width of 7 mm. (0.2756 in.), a diameter of the apertures, holes or openings 72 of 1 mm. (0.0394 in.) has been found suitable but is subject to the caveat appearing below. The intermediate ring 56B also includes a plurality, preferably three or six, axially extending, circumferentially equally spaced apart lugs or projections 74. The lugs or projections 74 extend toward the center of the synchronizer assembly 30.

Referring now to FIGS. 4 and 6, the inner ring 58B, which, as illustrated in FIG. 4, is seated within the intermediate ring 56B, also includes a plurality of radially oriented, circumferentially spaced apart through lubrication apertures, holes or openings 76. The lubrication openings 76 allow and encourage lubricating oil to flow into the interface between the outer surface of the inner ring 58B and the inner surface of the intermediate ring 56B. While the number of openings 76 and their diameter may vary, for example, according to the diameter and width of the inner ring 58B, a range of from eight to sixteen openings 76 has been found functional and between ten and fourteen is preferred. In a typical inner ring 58B having a width of 7 mm. (0.2756 in.), a diameter of the apertures, holes or openings 76 of 1 mm. (0.0394 in.) has been found suitable but is subject to the caveat appearing below. The inner ring 58B also includes a plurality of axial slots or channels 78 on its outer surface which further assist distribution of lubrication. The inner ring 58B also includes a plurality, preferably three, axially extending, circumferentially equally spaced apart lugs or projections 82. The lugs or projections 82 extend away the center of the synchronizer assembly 30 in a direction opposite to that of the lugs or projections 74 on the intermediate ring 56B.

It will be appreciated that rotation of the inner rings 58A and 58B and intermediate rings 56A and 56B during operation and the centrifugal forces generated thereby significantly assist in the outward migration of lubricating oil which not only reduces friction between the rings thereby reducing heat generation and operating temperatures but also assists in carrying away and dissipating the heat that is generated resulting in improved synchronizer reliability and service life. While the lubrication holes or openings 72 in the intermediate rings 56A and 56B and the lubrication holes or openings 76 in the inner rings 58A and 58B enhance the lubrication characteristics of the synchronizer assembly 30, they also introduce some local stress concentrations. Therefore, the strength of the rings 56A, 56B, 58A and 58B should be considered as a limiting factor with regard to the size and the number of holes or openings 72 and 76 placed in the intermediate rings 56A and 56B and the inner rings 58A and 58B, respectively.

The description of the invention is merely exemplary in nature and variations that do not depart from the gist of the invention are intended to be within the scope of the invention. Such variations are not to be regarded as a departure from the spirit and scope of the invention.

What is claimed is:

1. A synchronizer assembly for a transmission comprising, in combination,
an outer, blocker ring,
an intermediate ring adjacent said outer ring, and
an inner ring adjacent said intermediate ring,
said intermediate ring and said inner ring including a plurality of lubrication openings.

2. The synchronizer assembly of claim 1 wherein said blocker ring includes a plurality of circumferentially spaced apart segments of teeth.

3. The synchronizer assembly of claim 1 wherein said intermediate ring includes a plurality of circumferentially spaced apart, axially extending lugs.

4. The synchronizer assembly of claim 1 wherein said inner ring includes an outer surface interrupted by a plurality of circumferentially spaced apart, axially extending slots.

5. The synchronizer assembly of claim 1 wherein said inner ring includes a plurality of circumferentially spaced apart, axially extending lugs.

6. The synchronizer assembly of claim 1 wherein said intermediate ring includes a first plurality of circumferentially spaced apart lugs extending axially in a first direction and said inner ring includes a second plurality of circumferentially spaced apart lugs extending axially in a second direction.

7. The synchronizer assembly of claim 1 wherein said inner ring includes and outer surface interrupted by a plurality of circumferentially spaced apart, axially extending slots and said plurality of lubrication openings alternate with said slots.

8. A synchronizer assembly for a transmission comprising, in combination,
an outer, blocker ring having a plurality of circumferentially spaced apart segments of teeth,
an intermediate ring adjacent said outer ring, said intermediate ring having a first plurality of circumferentially spaced apart, axially extending lugs, and
an inner ring adjacent said intermediate ring, said inner ring having a second plurality of circumferentially spaced apart, axially extending lugs,
said intermediate ring and said inner ring each including a plurality of radially oriented openings.

9. The synchronizer assembly of claim 8 wherein said inner ring includes an outer surface having a plurality of circumferentially spaced apart, axially extending slots.

10. The synchronizer assembly of claim 9 wherein said plurality of circumferentially spaced apart, axially extending slots on said outer surface alternate with said plurality of radially oriented openings.

11. The synchronizer assembly of claim 8 wherein said first plurality of circumferentially spaced apart lugs extend axially in a first direction and said second plurality of circumferentially spaced apart lugs extend axially in a second direction.

12. The synchronizer assembly of claim 8 wherein said intermediate ring is disposed within said outer ring and said inner ring is disposed within said intermediate ring.

13. The synchronizer assembly of claim 8 wherein said pluralities of radial openings in said intermediate ring and said inner ring are lubrication flow openings.

14. A synchronizer assembly for a motor vehicle manual transmission comprising, in combination,
an outer, blocker ring having a plurality of circumferentially spaced apart segments of teeth,
an intermediate ring disposed within said outer ring, said intermediate ring having a first plurality of circumferentially spaced apart, axially extending lugs and a first plurality of lubrication openings, and
an inner ring disposed within said intermediate ring, said inner ring having a second plurality of lubrication openings and a second plurality of circumferentially spaced apart, axially extending lugs

15. The synchronizer assembly for a motor vehicle manual transmission of claim 14 wherein said first plurality of circumferentially spaced apart lugs extend axially in a first direction and said second plurality of circumferentially spaced apart lugs extend axially in a second direction.

16. The synchronizer assembly for a motor vehicle manual transmission of claim 14 wherein said first plurality of circumferentially spaced apart lugs extend axially in one direction and said second plurality of circumferentially spaced apart lugs extend axially in an opposite direction.

17. The synchronizer assembly for a motor vehicle transmission of claim 14 wherein said inner ring includes an outer surface having a plurality of circumferentially spaced apart, axially extending slots.

18. The synchronizer assembly for a motor vehicle transmission of claim 17 wherein said plurality of circumferentially spaced apart, axially extending slots on said outer surface of said inner ring alternate with said second plurality of radially oriented lubrication openings.

19. The synchronizer assembly for a motor vehicle transmission of claim 14 wherein said first and said second pluralities of lubrication openings are radially oriented.
